(19) United States
(12) Patent Application Publication
(10) Pub. No.: US 2026/0217091 A1
(43) Pub. Date: Jul. 30, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/424,459

(22) Filed: Dec. 18, 2025

(30) Foreign Application Priority Data
Jan. 27, 2025 (JP) 2025-011704

(51) Int. Cl. B60H 3/06; B01D 53/04

(52) U.S. Cl. CPC B60H 3/0633; B01D 53/0438; B01D 2259/40096; B60H 2003/0691

(57) ABSTRACT

A vehicle air conditioning system includes an adsorption device including: first and second adsorption portions provided in parallel to each other, each of the first adsorption portion and the second adsorption portion containing an adsorbent configured to adsorb at least one removal target component at a temperature equal to or lower than a predetermined temperature and to desorb the adsorbed removal target component when the temperature exceeds the predetermined temperature; a heating means configured to heat each of the first adsorption portion and the second adsorption portion; and at least one casing for holding the first adsorption portion and the second adsorption portion in an integrated manner, wherein the first adsorption portion and the second adsorption portion are provided to form a gap between them, and wherein the casing includes at least one support inserted into the gap between the first adsorption portion and the second adsorption portion.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Patent Literature 1 proposes a vehicle air conditioning (air purifying) system including: a first flow path and a second flow path that are in communication with a vehicle interior; and a first adsorption portion and a second adsorption portion (adsorption block) located in each flow path. While one of the first adsorption portion and the second adsorption portion adsorb removal target components, the other of the first adsorption portion and the second adsorption portion is regenerated by heating.

### CITATION LIST

### Patent Literatures

[Patent Literature 1] Japanese Patent Application Publication No. 2020-104774 A

### SUMMARY OF THE INVENTION

In the conventional structure described in Patent Literature 1, the first adsorption portion is disposed in the first flow path and the second adsorption portion is disposed in the second flow path, which increases the number of steps required for disposing the first adsorption portion and the second adsorption portion. In order to reduce the number of disposing steps, it is considered that the first adsorption portion and the second adsorption portion are held by a casing in an integrated manner. However, when the first adsorption portion and the second adsorption portion are adjacent to each other in the casing, the heat that regenerates one of the first adsorption portion and the second adsorption portion by heating increases the temperature of the other of the first adsorption portion and the second adsorption portion, thereby reducing an adsorption efficiency of the other.

This invention has been made to solve the problems described above, and one of objects thereof is to provide a vehicle air conditioning system that can suppress a decrease in an adsorption efficiency of other of the first adsorption portion and the second adsorption portion due to the heat from one of the first adsorption portion and the second adsorption portion, while reducing the number of steps required for disposing the first adsorption portion and the second adsorption portion.

[1] In an embodiment, this invention relates to a vehicle air conditioning system, comprising an adsorption device comprising: a first adsorption portion and a second adsorption portion provided in parallel to each other, each of the first adsorption portion and the second adsorption portion comprising an adsorbent configured to adsorb at least one removal target component at a temperature equal to or lower than a predetermined temperature and to desorb the adsorbed removal target component when the temperature exceeds the predetermined temperature; a heating means configured to heat each of the first adsorption portion and the second adsorption portion; and at least one casing for holding the first adsorption portion and the second adsorption portion in an integrated manner, wherein the first adsorption portion and the second adsorption portion are provided to form a gap between them, and the casing comprises at least one support inserted into the gap between the first adsorption portion and the second adsorption portion.

[2] This invention may relate to the vehicle air conditioning system according to [1], wherein, when a direction in which the first adsorption portion and the second adsorption portion are spaced apart from each other is defined as a first direction, a direction which is orthogonal to the first direction and in which first end faces of the first adsorption portion and the second adsorption portion and second end faces of the first adsorption portion and the second adsorption portion are spaced apart from each other is defined as a second direction, and a direction orthogonal to the first direction and the second direction is defined as a third direction, a width W, a height H, and a length L satisfy the following equation:

$$80.2 - 8.19 \times W + 2.4 \times H - 0.3358 \times L - 0.0804 \times ( L - 71.3 ) \times ( H / 2 - 2.38 ) \leq 80$$

in which the width W is a dimension (mm) of the support in the first direction; the height H is a dimension (mm) of the support in the second direction; and the length L is a dimension (mm) of the support in the third direction.

[3] This invention may relate to the vehicle air conditioning system according to [1] or [2], wherein a ratio W/W0 of the width W to a dimension W0 between outer ends of the casing in the first direction is 0.0410 or less.

[4] This invention may relate to the vehicle air conditioning system according to [3], wherein the ratio W/W0 of the width W is 0.0369 or less.

[5] This invention may relate to the vehicle air conditioning system according to any one of [1] to [4], wherein the casing comprises a material having a thermal conductivity of 3.0 W/m/K or less at 25° C. as measured in accordance with JIS R1611: 2010.

[6] This invention may relate to the vehicle air conditioning system according to [5], wherein the material of the casing is a resin.

[7] This invention may relate to the vehicle air conditioning system according to any one of [1] to [6], wherein each of the first adsorption portion and the second adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer comprising an adsorbent provided on a surface of each of the partition walls, and wherein the heating means has a pair of electrodes connected to the honeycomb structure, the heating means being configured to heat the honeycomb structure by passing a current through the honeycomb structure via the pair of electrodes, and wherein at least the partition walls of the honeycomb structure comprises a material having a PTC property.

According to an embodiment of the vehicle air conditioning system of this invention, the casing includes the support inserted into the gap between the first adsorption portion and the second adsorption portion, so that a decrease in an adsorption efficiency of other of the first adsorption portion and the second portion due to the heat from one of the first adsorption portion and the second portion can be suppressed while reducing the number of steps required for disposing the first adsorption portion and the second adsorption portion.

### BRIEF DESCRIPTION OF THE DRAWINGS

FIG. 1 is a schematic view of a vehicle air conditioning system 1 according to an embodiment of the invention;

FIG. 2 is an enlarged schematic view of the adsorption device in FIG. 1;

FIG. 3 is a left side view illustrating the adsorption device in FIG. 2;

FIG. 4 is a cross-sectional view of the first adsorption portion and the second adsorption portion taken along the line IV-IV in FIG. 2;

FIG. 5 is a cross-sectional view of the casing taken along the line V-V in FIG. 4;

FIG. 6 is a variation of the bridge portion in FIG. 5;

FIG. 7 is a perspective view of the adsorption device in FIG. 2;

FIG. 8 is an exploded perspective view of the adsorption device in FIG. 7;

FIG. 9 is an explanatory view schematically illustrating the relationship between the first adsorption portion and the second adsorption portion, the first electrode and the second electrode, and the first metal terminal and the second metal terminal in FIG. 7;

FIG. 10 is an enlarged view illustrating the region X in FIG. 7;

FIG. 11 is an explanatory view illustrating the dimensions of the honeycomb structure used in Examples;

FIG. 12 is a graph illustrating temperature increasing properties of the honeycomb structure used in Examples;

FIG. 13 is a graph illustrating the maximum end face temperature of the adsorption-side honeycomb structure obtained in Examples when the length L of the support is 120 mm;

FIG. 14 is a graph illustrating the maximum end face temperature of the adsorption-side honeycomb structure obtained in Examples when the length L of the support is 60 mm;

FIG. 15 is an explanatory view illustrating an arrangement mode of a sample of an adsorption device according to Example;

FIG. 16 is a graph illustrating results of studies for an increasing rate of pressure loss in Examples; and

FIG. 17 is a graph illustrating results of studies for a decreasing rate of an amount of moisture absorbed in Examples.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Vehicle Air Conditioning System)

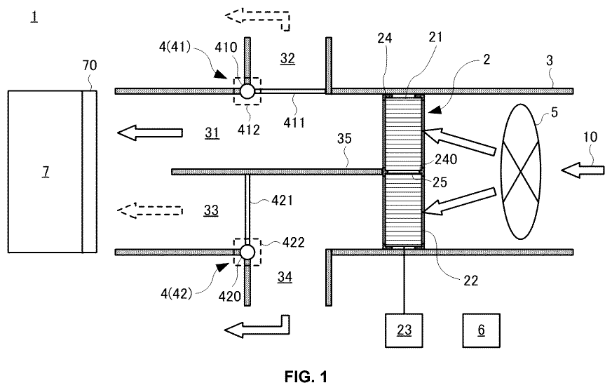

FIG. 1 is a schematic view of a vehicle air conditioning system 1 according to an embodiment of the invention. The vehicle air conditioning system 1 according to an embodiment is a system mounted on a vehicle. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system 1 according to an embodiment can be suitably used for a vehicle that has no internal combustion engine such as electric vehicles and electric rail cars.

As illustrated in FIG. 1, the vehicle air conditioning system 1 includes an adsorption device 2.

The adsorption device 2 includes a first adsorption portion 21, a second adsorption portion 22, a heating means 23, and a casing 24.

Each of the first adsorption portion 22 and the second adsorption portion 23 contains an adsorbent capable of adsorbing at least one removal target component at a temperature equal to or lower than a predetermined temperature and desorbing the removal target component when the temperature exceeds the predetermined temperature. The first adsorption portion 21 and the second adsorption portion 22 may have the same shape. The removal target component can include, for example, moisture, carbon dioxide, and volatile components. The first adsorption portion 21 and the second adsorption portion 22 are provided in parallel to each other. In other words, the first adsorption portion 21 and the second adsorption portion 22 are provided side by side in a direction intersecting (preferably orthogonal to) a flow direction of an air 10 in a duct 3 described below. The flow direction of the air 10 may be in an extending direction of the duct 3. The air 10 that has passed through one of the first adsorption portion 21 and the second adsorption portion 22 flows toward the downstream without passing through the other. As the air 10 passes through the first adsorption portion 21 and the second adsorption portion 22, the removal target component contained in the air 10 is adsorbed by the adsorbents in the first adsorption portion 21 and the second adsorption portion 22.

The heating means 23 is configured to heat each of the first adsorption portion 22 and the second adsorption portion 23. Heating of the first adsorption portion 22 and the second adsorption portion 23 by the heating means 23 desorbs the removal target component from the adsorbents in the first adsorption portion 22 and the second adsorption portion 23. The desorption of the removal target component by heating with the heating means 23 may be referred to as a heating regeneration of the first adsorption portion 21 and the second adsorption portion 22.

The casing 24 holds the first adsorption portion 21 and the second adsorption portion 22 in an integrated manner. FIG. 1 illustrates a cross section of the casing 24 at a position of at least one support 240, which will be described later. The casing 24 does not cover the first adsorption portion 21 and the second adsorption portion 22 on both sides of the support 240 (top and bottom on the paper in FIG. 1), and the air 10 can pass through the first adsorption portion 21 and the second adsorption portion 22 on both sides of the support 240.

The vehicle air conditioning system 1 may further include a duct 3, a valve 4, a blower 5 and a control unit 6.

The duct 3 is a pipe in which the adsorption device 2 is provided. The duct 3 is configured to allow an air 10 from a vehicle interior or a vehicle exterior to flow therethrough. The duct 3 has a first flow path 31, a second flow path 32, a third flow path 33 and a fourth flow path 34 on a downstream side of the adsorption device 2. The first flow path 31 is a flow path for allowing the air 10 that has passed through the first adsorption portion 21 to flow into the vehicle interior. The second flow path 32 is a flow path for discharging the air 10 that has passed through the first adsorption portion 2 to the vehicle exterior. The third flow path 33 is a flow path for allowing the air 10 that has passed through the second adsorption portion 22 to flow into the vehicle interior. The fourth flow path 34 is a flow path for discharging the air 10 that has passed through the second adsorption portion 22 to the vehicle exterior. The first flow path 31 and the third flow path 33 are separated from each other by a duct partition wall 35. The first flow path 31 and the third flow path 33 may join together in the duct 3 as illustrated in FIG. 1, or may be separated by the duct partition wall 35 to an outlet of the duct 3. The second flow path 32 branches from the first flow path 31, and the fourth flow path 34 branches from the third flow path 33.

The valve 4 has a first valve 41 that switches the flow of the air 10 that has passed through the first adsorption portion 21 between the first flow path 31 and the second flow path 32, and a second valve 42 that switches the flow of the air 10 that has passed through the second adsorption portion 22 between the third flow path 33 and the fourth flow path 34. The first valve 41 allows the air 10 to flow through the first flow path 31 when the removal target component in the air 10 is adsorbed to the first adsorption portion 21, and allows the air 10 to flow through the second flow path 32 when the removal target component is desorbed from the first adsorption portion 21. Similarly, the second valve 42 allows the air 10 to flow through the third flow path 33 when the removal target component in the air 10 is adsorbed to the second adsorption portion 22, and allows the air 10 to flow through the fourth flow path 34 when the removal target component is desorbed from the second adsorption portion 22. FIG. 1 illustrates a state where the air 10 that has passed through the first adsorption portion 21 is allowed to flow through the first flow path 31, and the air 10 that has passed through the second adsorption portion 22 is allowed to flow through the fourth flow path 34.

The first valve 42 and the second valve 42 are not particularly limited as long as they are valves that are electrically driven and have the function of switching the flow paths, and include electromagnetic valves and electric valves. In an embodiment, each of the first valve 42 and the second valve 43 includes an opening/closing door 411, 421 supported by a rotating shaft 410, 420 and an actuator 412, 422 such as a motor that rotates the rotating shaft 410, 420.

The blower 5 is configured to send the air 10 from the vehicle interior or the vehicle exterior to the adsorption device 2. The blower 5 may be provided inside the duct 3. The blower 5 may be provided upstream of the first adsorption portion 21 and the second adsorption portion 22 in the flow direction of the air 10. In the illustrated embodiment, one blower 5 is provided in common to the first adsorption portion 21 and the second adsorption portion 22. However, the blower 5 may include a first blower that sends the air 10 to the first adsorption portion 21 and a second blower that sends the air 10 to the second adsorption portion 22.

The control unit 6 is configured to control the adsorption device 2, the valve 4 and the blower 5. The control unit 6 may be electrically connected to the adsorption device 2, the valve 4, and the blower 5 by wire or wirelessly. The control mode of the control unit 6 may include a first mode and a second mode. The first mode is a mode in which the blower 5 is activated so that the air 10 passes through the first adsorption portion 21 and the second adsorption portion 22, the second adsorption portion 22 is heated by the heating means 23 while the first adsorption portion 21 is not heated, and the air 10 is allowed to flow through the first flow path 31 and the fourth flow path 34. The second mode is a mode in which the blower 5 is activated so that the air 10 passes through the first adsorption portion 21 and the second adsorption portion 22, the first adsorption portion 21 is heated by the heating means 23 while the second adsorption portion 22 is not heated, and the air 10 is allowed to flow through the second flow path 32 and the third flow path 33. That is, the control unit 6 executes adsorption of the removal target component in one of the first adsorption portion 21 and the second adsorption portion 22, and also executes desorption (heating regeneration) of the removal target component in the other of the first adsorption portion 21 and the second adsorption portion 22. By alternately executing the first mode and the second mode, the removal target component can be adsorbed and desorbed without interruption.

The outlets of the first flow path 31 and the third flow path 33 may be positioned to face an HVAC intake port 70 of an HVAC unit 7. The outlets of the second flow path 32 and the fourth flow path 34 may be positioned so as to be displaced from the HVAC intake port 70. The HVAC system 7 is a unit for performing heating, ventilation, and air conditioning in a vehicle. The HVAC unit 7 can send the air 10 drawn in from the HVAC intake port 70 to the vehicle interior. It is intended that the air 10 flowing through the first flow path 31 and the third flow path 33 is fed to the vehicle interior through the HVAC unit 7, and the air 10 flowing through the second flow path 32 and the fourth flow path 34 is discharged to the vehicle exterior without passing through the HVAC unit 7.

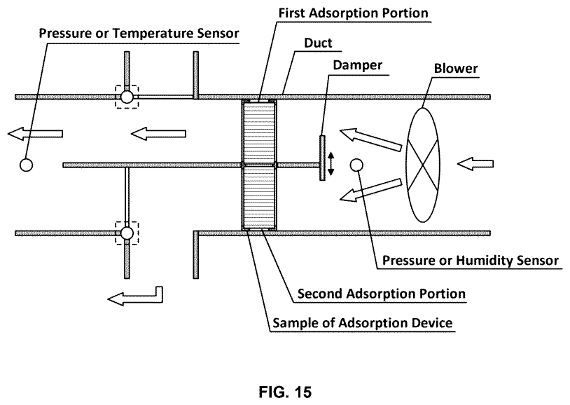

A flow path for the first adsorption portion 21 and a flow path for the second adsorption portion 22 may be provided in the duct 3 on an upstream side of the adsorption device 2, and a flow rate adjusting means such as a variable damper may be provided to adjust a flow rate of the air 10 flowing through these flow paths (see FIG. 15 below). The duct 3 may be of split type, and the adsorption device 2 may be sandwiched between parts forming the duct 3 from the upstream side and the downstream side.

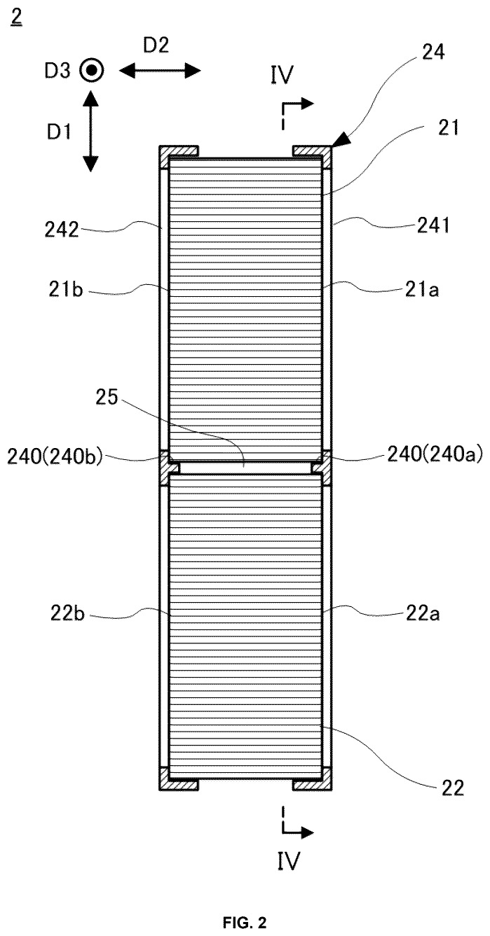

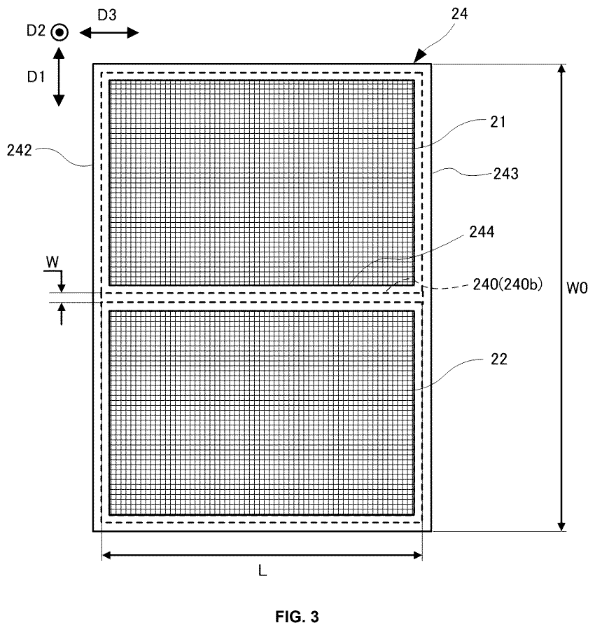

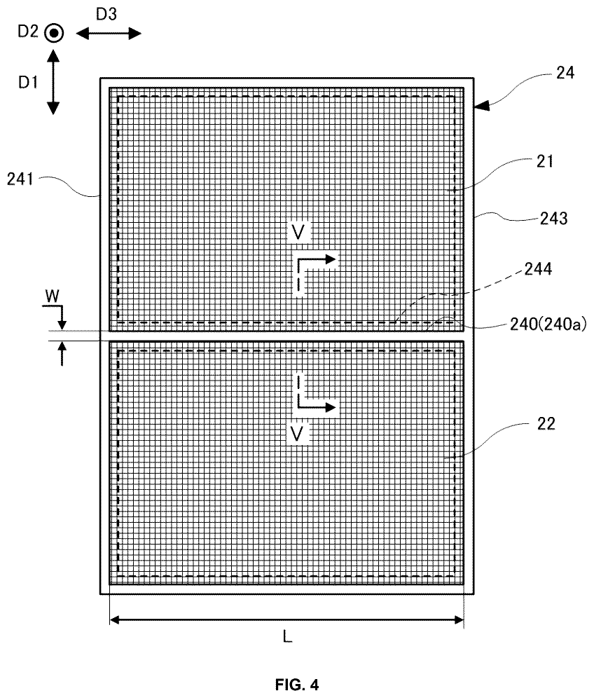

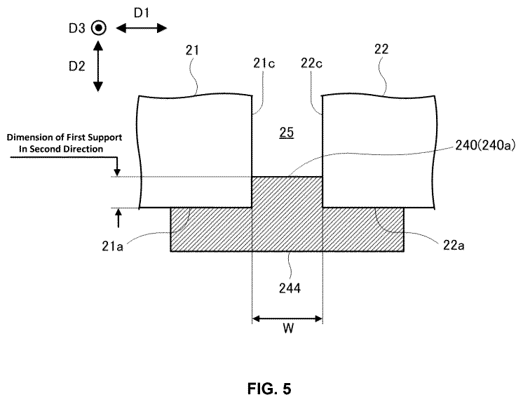

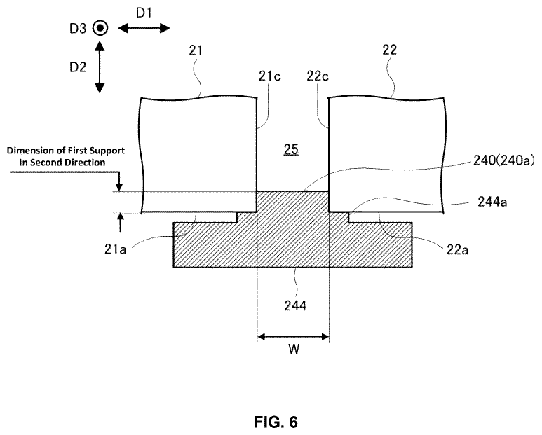

Next, FIG. 2 is an enlarged schematic view of the adsorption device 2 in FIG. 1, FIG. 3 is a left side view illustrating the adsorption device 2 in FIG. 2, FIG. 4 is a cross-sectional view of the first adsorption portion 21 and the second adsorption portion 22 taken along the line IV-IV in FIG. 2, FIG. 5 is a cross-sectional view of a casing 24 taken along the line V-V in FIG. 4, and FIG. 6 is a variation of a bridge portion 244 in FIG. 5.

As particularly illustrated in FIG. 2, the first adsorption portion 21 and the second adsorption portion 22 are disposed so as to form a gap 25 between them. The casing 24 has a support 240 inserted into the gap 25 between the first adsorption portion 21 and the second adsorption portion 22.

As in this embodiment, by holding the first adsorption portion 21 and the second adsorption portion 22 in an integrated manner by the casing 24, the number of steps required for disposing the first adsorption portion 21 and the second adsorption portion 22 can be reduced. If the first adsorption portion 21 and the second adsorption portion 22 are adjacent to each other in the casing 24, the heat for heating regeneration of one of the first adsorption portion 21 and the second adsorption portion 22 increases the temperature of the other of the first adsorption portion 21 and the second adsorption portion 22, thereby reducing an adsorption efficiency of the other. As in this embodiment, the casing 24 has the support 240 inserted into the gap 25 between the first adsorption portion 21 and the second adsorption portion 22, so that the first adsorption portion 21 and the second adsorption portion 22 can be maintained apart from each other in the case 24, and a decrease in the adsorption efficiency of the other (adsorption side) due to heat from one (thermal regeneration side) of the first adsorption portion 21 and the second adsorption portion 22 can be suppressed.

As particularly illustrated in FIG. 2, the casing 24 may have a first casing body 241 disposed on first end faces 21a, 22a side of the first adsorption portion 21 and the second adsorption portion 22, and a second casing body 242 disposed on second end faces 21b, 22b side of the first adsorption portion 21 and the second adsorption portion 22. The first end faces 21a, 22a are one end faces of the first adsorption portion 21 and the second adsorption portion 22 in the flow direction of the air 10 (see FIG. 1), and the second end faces 21b, 22b are the other end faces of the first adsorption portion 21 and the second adsorption portion 22 in the flow direction of the air 10. The first adsorption portion 21 and the second adsorption portion 22 are integrally sandwiched between the first casing body 241 and the second casing body 242. Any method of sandwiching the first adsorption portion 21 and the second adsorption portion 22 between the first casing body 241 and the second casing body 242 may be employed, but for example, a method of fastening the first casing body 241 and the second casing body 242 to each other using fastening members such as bolts and nuts (not shown) may be employed.

The support 240 may be provided on at least one of the first casing body 241 and the second casing body 242. In the illustrated embodiment, the supports 240 are provided on both the first casing body 241 and the second casing body 242.

As particularly illustrated in FIG. 3, the casing 24 (first casing body 241 and second casing body 242) may have a frame portion 243 and a bridge portion 244.

The frame portion 243 is superimposed onto the overall outer periphery of the first adsorption portion 21 and the second adsorption portion 22 that are disposed in parallel or side by side. In the illustrated embodiment, the outer shape of the frame portion 243 is rectangular in correspondence with the rectangular outer shapes of the first adsorption portion 21 and the second adsorption portion 22. However, the outer shapes of the first adsorption portion 21, the second adsorption portion 22 and the frame portion 243 can be changed as desired. For example, the first adsorption portion 21 and the second adsorption portion 22 may have a semicircular outer shape, and the frame portion 243 may have a circular outer shape.

As particularly illustrated in FIG. 3, the frame portion 243 has an opening in the center, and the bridge portion 244 connects the inner edges of the frame portion 243 across the opening of the frame portion 243. The bridge portion 244 is disposed so as to straddle the outer peripheries of the first adsorption portion 21 and the second adsorption portion 22 at a position where the first adsorption portion 21 and the second adsorption portion 22 are close to each other. As particularly illustrated in FIG. 5, the inner surface of the bridge portion 244 is disposed in contact with the first end faces 21a, 22a (or second end faces 21b, 22b) of the first adsorption portion 21 and the second adsorption portion 22. As shown in FIG. 6, the inner surface of the bridge portion 244 may be provided with a step portion 244a, and the inner surface of the step portion 244a may be positioned in contact with the first end faces 21a, 22a (or second end faces 21b, 22b) of the first adsorption portion 21 and the second adsorption portion 22.

As particularly illustrated in FIGS. 5 and 6, the supports 240 protrude inward of the casing 24 from the inner surface of the bridge portion 244 or the step portion 244a. The support 240 is disposed so as to be in contact with the outer peripheral surfaces 21c, 22c of the first adsorption portion 21 and the second adsorption portion 22.

Here, the direction in which the first adsorption portion 21 and the second adsorption portion 22 are spaced apart from each other is defined as a first direction D1, the direction which is orthogonal to the first direction D1 and in which the first end faces 21a, 22a of the first adsorption portion 21 and the second adsorption portion 22 and the second end faces 21b, 22b of the first adsorption portion 21 and the second adsorption portion 22 are spaced apart from each other is defined as a second direction D2, and the direction orthogonal to the first direction D1 and the second direction D2 is defined as a third direction D3. Furthermore, the dimension of the support 240 in the first direction D1 is defined as a width W (mm), the dimension of the support 240 in the second direction D2 is defined as a height H (mm), and the dimension of the support 240 in the third direction D3 is defined as a length L (mm).

If the width W (mm) is narrower, the distance over which heat is transferred is shorter, and therefore the temperature is easily transferred from the heating regeneration side to the adsorption side. As the height H increases, the heat is more easily transferred through the support 240. This is based on the idea that the air exists between the first adsorption portion 21 and the second adsorption portion 22 at positions where there is no support 240, and that the air has better heat insulating properties than the supports 240. If the length L is shorter, the heat is concentrated, and therefore the temperature on the adsorption side easily increases.

The width W, the height H and the length L preferably satisfy the following equation:

$$80.2 - 8.19 \times W + 2.4 \times H - 0.3358 \times L - 0.0804 \times ( L - 71.3 ) \times ( H / 2 - 2.38 ) \leq 80$$

The left side of this equation represents the end face temperature of the other of the first adsorption portion 21 and the second adsorption portion 22 when one of them is subjected to the heating regeneration. By satisfying the above equation, the end face temperature of the other of the first adsorption portion 21 and the second adsorption portion 22 can be maintained at a temperature equal to or lower than 80° C., and a decrease in an adsorption efficiency of other of the first adsorption portion 21 and the second adsorption portion 22 due to heat from one of the first adsorption portion 21 and the second adsorption portion 22 can be more reliably suppressed.

The above equation can also be rearranged as follows:

$$- 8.19 \times W + 5.26 \times H + 0.12 \times L - 0.804 \times L \times H \leq 5.50$$

As described above, in this embodiment, the supports 240 are provided on both the first casing body 241 and the second casing body 242. The support 240 provided at the first casing body 241 is called a first support 240a (see FIG. 2), and the support 240 provided at the second case body 242 is called a second support 240b (see FIG. 2).

The dimension of the first support 240a in the first direction D1 and the dimension of the second support 240b in the first direction D1 may be the same as or different from each other. When these dimensions are the same, the width W (mm) is the dimension of the first support 240a or the second support 240b in the first direction D1. When these dimensions are different, the width W (mm) is the larger one of these dimensions.

The dimension of the first support 240a in the second direction D2 and the dimension of the second support 240b in the second direction D2 may be the same as or different from each other. Regardless of whether these dimensions are the same as or different from each other, the height H is the sum of the dimension of the first support 240a and the dimension of the second support 240b in the second direction D2. As shown in FIGS. 5 and 6, the dimension of the first support 240a in the second direction D2 is based on the height positions of the first end faces 21a, 22a of the first adsorption portion 21 and the second adsorption portion 22. Although not shown, the dimension of the second support 240b in the second direction D2 is based on the height positions of the second end faces 21b, 22b of the first adsorption portion 21 and the second adsorption portion 22.

The dimension of the first support 240a in the third direction D3 and the dimension of the second support 240b in the third direction D3 may be the same as or different from each other. When these dimensions are the same, the length W (mm) is the dimension of the first support 240a or the second support 240b in the first direction D3. When these dimensions are different, the length W (mm) is the larger one of these dimensions.

As the width W increases, the ventilation area of the first adsorption portion 21 and the second adsorption portion 22 decreases, and the pressure loss of the first adsorption portion 21 and the second adsorption portion 22 increases. From the viewpoint of suppressing an increase in pressure loss, it is more preferable that a ratio W/W0 of the width W to a dimension W0 (see FIG. 3) between the outer ends of the casing 24 in the first direction D1 is 0.0410 or less. Further, as the width W increases, the ventilation area of the first adsorption portion 21 and the second adsorption portion 22 decreases, and the amount of the removal target component adsorbed in the first adsorption portion 21 and the second adsorption portion 22 decreases. From the viewpoint of suppressing a decrease in the amount of the removal target component adsorbed, it is even more preferable that the ratio W/WV0 is 0.0369 or less. For example, when the dimension W0 between the outer ends of the casing 24 is 122 mm and the width W is 5.0 mm, the ratio W/W0 is 0.0410, and when the width W is 4.5 mm, the ratio W/W0 is 0.0369. From the viewpoint of heat insulation, the lower limit of the width W is considered to be 2.0 mm. When the dimension W0 between the outer ends of the casing 24 is 122 mm, the ratio W/WV0 is preferably 0.0164 or more.

When the supports 240 are provided at both the first casing body 241 and the second casing body 242, the height H is equal to or less than ½ of the dimension of the first adsorption portion 21 and the second adsorption portion 22 in the second direction D2. When the support 240 is provided at only one of the first casing body 241 and the second casing body 242, the height H is equal to or less than the dimension of the first adsorption portion 21 and the second adsorption portion 22 in the second direction D2. From the viewpoint of heat insulation, the upper limit of the height H is considered to be 5.0 mm. Further, from the viewpoint of preventing contact between the first adsorption portion 21 and the second adsorption portion 22, the lower limit of the height H is considered to be 0.05 mm.

The length L is equal to or less than the dimension of the first adsorption portion 21 and the second adsorption portion 22 in the third direction D3. When the length L (mm) is less than this dimension, the positions of the first support 240a and the second support 240b in the third direction D3 are arbitrary. When the length L (mm) is less than that dimension, the first support 240a and the second support 240b may be disposed so that the central positions of the first adsorption portion 21 and the second adsorption portion 22 in the third direction D3 coincide with the central positions of the first support 240a and the second support 240b in the third direction D3. From the viewpoint of heat insulation, the lower limit of the length L is considered to be 30 mm.

The casing 24 is made of a material having a thermal conductivity of 3.0 W/m/K or less at 25° C. as measured in accordance with JIS R1611: 2010. By making the casing 24 using such a material, heat conduction through the casing 24 can be suppressed, and the decrease in the adsorption efficiency of the other of the first adsorption portion 21 and the second adsorption portion 22 due to heat from one of the first adsorption portion 21 and the second adsorption portion 22 can be more reliably suppressed.

Such a material includes, for example, resins, ceramics, and glass wool, but from the viewpoint of impact resistance, the casing 24 may preferably be made of the resin. Examples of the resins that can be used as the material for the casing 24 include polyphenylene sulfide, polybutylene terephthalate, and nylon 66. From the viewpoint of low water absorption and hydrolysis resistance, polyphenylene sulfide is particularly preferably used as the material for the casing 24. Furthermore, inorganic substances such as glass may be added to the resin.

### (2. Regarding Adsorption Device)

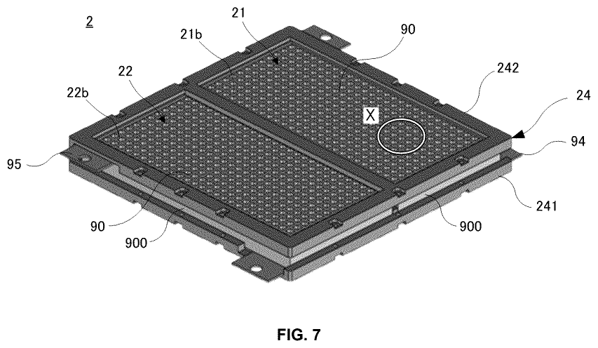

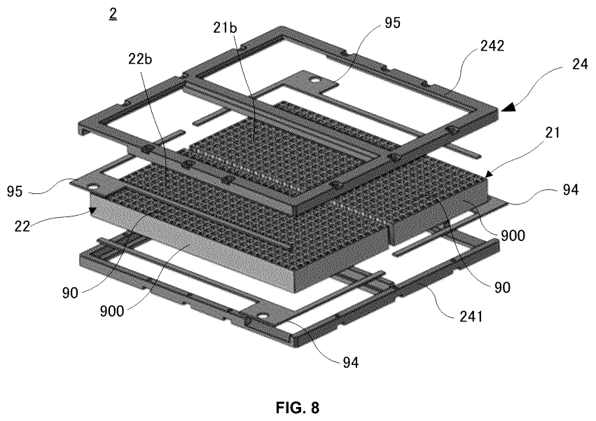

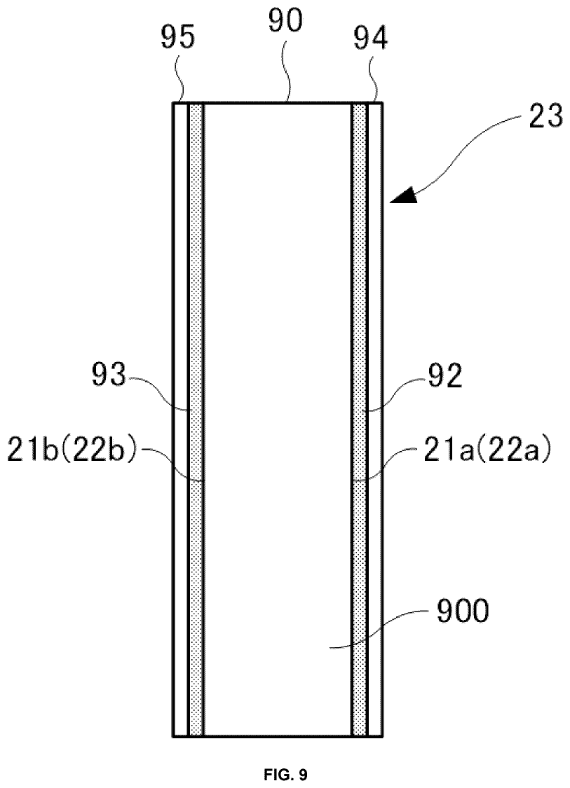

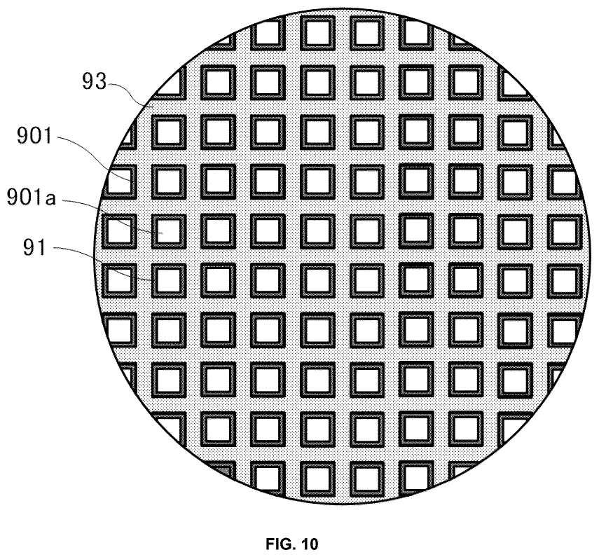

Next, FIG. 7 is a perspective view illustrating the adsorption device 2 in FIG. 2, and FIG. 8 is an exploded perspective view illustrating the adsorption device 2 in FIG. 7. FIG. 9 is an explanatory view schematically illustrating the relationship between a honeycomb structure 90, a first electrode 92 and a second electrode 93, and a first metal terminal 94 and a second metal terminal 95 in FIG. 7, and FIG. 10 is an enlarged view illustrating the region X in FIG. 7.

As illustrated in FIGS. 7 to 10, each of the first adsorption portion 21 and the second adsorption portion 22 of the adsorption device 2 according to this embodiment has a honeycomb structure 90 and adsorbing layers 91. The honeycomb structure 90 includes: an outer wall 900; and partition walls 901 provided on an inner side of the outer wall 900, the partition walls 701 defining cells 901a to form flow paths for the air 10 each extending from first end face 21a, 22a to second end face 21b, 22b of the honeycomb structure 90. The adsorbing layer 91 is a layer containing the adsorbent as described above, and is provided on each surface of the partition walls 901 as illustrated in FIG. 10. As the air 10 passes through the cells 901a between the first end face 21a, 22a and the second end face 21b, 22b, the removal target component in the air 10 is adsorbed by the adsorbents in the adsorbing layers 91.

In such an adsorption device 2, the heating means 23 has a pair of electrodes 92, 93 connected to the honeycomb structure 90, and heats the honeycomb structure 90 by applying an electric current to the honeycomb structure 90 through the pair of electrodes 92, 93. Hereinafter, when the pair of electrodes 92, 93 are to be distinguished from each other, one will be referred to as a first electrode 92 and the other as a second electrode 93.

As particularly illustrated in FIG. 9, the first electrode 92 is provided on the first end face 21a, 22a of the honeycomb structure 90, and the second electrode 93 is provided on the second end face 21b, 22b of the honeycomb structure 90. As illustrated in FIG. 10, the second electrode 93 is provided on the end face of the outer wall 900, and also provided on the end face of the partition walls 901. The same is true for the first electrode 92, which is not shown. The cells 901a do not plug the first electrode 92 and the second electrode 93. However, a part of cells 901a may be plugged by the first electrode 92 and/or the second electrode 93.

As shown in FIGS. 7 to 9, a first metal terminal 94 may be provided on the first electrode 92, and a second metal terminal 95 may be provided on the second electrode 93. The first metal terminal 94 and the second metal terminal 95 are L-shaped and attached to the outer peripheries of the first end faces 21a, 22a and the second end faces 21b, 22b, respectively. The first metal terminal 94 and the second metal terminal 95 are provided with extending portions each extending from the rectangular frame outward in the width direction of the honeycomb structure 90.

A positive electrode of a power source (not shown) is connected to one extending portion of the first metal terminal 94 and the second metal terminal 95, and a negative electrode of the power source is connected to the other extending portion of the first metal terminal 94 and the second metal terminal 95. Assuming that the positive electrode is connected to an extending portion of the first metal terminal 94 and the negative electrode is connected to an extending portion of the second metal terminal 95, the current from the first metal terminal 94 spreads over the first end face 21a, 22a through the first electrode 92, flows through the honeycomb structure 90 in the extending direction of the cells 901a, and flows on the second end face 21b, 22b through the second terminal 93 into the second metal terminal 95. The current flows in such a manner, thereby heating the honeycomb structure 90 uniformly.

In the honeycomb structure 90, at least the partition walls 901 may be made of a material having a PTC (Positive Temperature Coefficient) property. Further, the material having the PTC property has characteristics such that when the temperature increases to exceed the Curie point, the resistance value is sharply increased, making it difficult for electricity to flow.

Hereinafter, each of the components of the adsorption device 2 will be described in detail.

### (2-1. Regarding Honeycomb Structure)

The shape of the honeycomb structure 90 is not particularly limited. For example, an outer shape of a cross section of the honeycomb structure 90 orthogonal to the flow path direction (extending direction of the cells 901a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 21a, 22a and second end face 22b, 22b) have the same shape as the cross section. Also, when the cross section and the end faces are polygonal, the corners may be chamfered.

The shape of each cell 901a is not particularly limited, but it may be polygonal such as quadrangular, pentagonal, hexagonal, heptagonal, and octagonal, circular, or oval in the cross section of the honeycomb structure 90 orthogonal to the flow path direction. These shapes may be alone or in combination of two or more. Moreover, among these shapes, the quadrangle or the hexagon is preferable. By providing the cells 901a having such a shape, it is possible to reduce the pressure loss when the air 10 flows. In FIGS. 7 to 10, the honeycomb structure 90 is illustrated as an example in which the outer shape of the cross section and the shape of each cell 901a are quadrangular in the cross section orthogonal to the flow path direction of the honeycomb structure 90.

The honeycomb structure 90 may be a honeycomb joined body that includes a plurality of honeycomb segments and joining layers that join outer peripheral side surfaces of the plurality of honeycomb segments together. The use of the honeycomb joined body can increase the total cross-sectional area of the cells 901a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 900 and the partition walls 901. In addition to the role of joining the honeycomb segments to each other, the joining material can also be used as an outer peripheral coating material after joining the honeycomb segments.

From the viewpoints of ensuring the strength of the honeycomb structure 90, reducing pressure loss when the air 10 passes through the cells 901a, ensuring the amount of functional material supported, and ensuring the contact area with the air 10 flowing inside the cells 901a, it is desirable to suitably combine a thickness of the partition wall 901, a cell density, and a cell pitch (or an opening ratio of the cells 901a).

As used herein, the cell density refers to a value obtained by dividing a number of cells by an area of one end face (first end face 21a, 22a or second end face 21b, 22b) of the honeycomb structure 90 (the total area of the partition walls 901 and the cells 901a excluding the outer wall 900).

As used herein, the cell pitch refers to a value obtained by the following calculation. First, the area of one end face (first end face 21a, 22a or second end face 21b, 22b) of the honeycomb structure 90 (the total area of the partition walls 901 and the cells 901a excluding the outer wall 900) is divided by the number of the cells to calculate an area per a cell. A square root of the area per a cell is then calculated, and this is determined to be the cell pitch.

As used herein, the opening ratio of the cells 901a refers a value obtained by dividing the total area of the cells 901a defined by the partition walls 901 by the area of one end face (first end face 21a, 22a or second end face 21b, 22b) (the total area of the partition walls 901 and the cells 901a excluding the outer wall 900) in the cross section orthogonal to the flow path direction of the honeycomb structure 90. In addition, when calculating the opening ratio of the cells 901a, the first electrode 92, the second electrode 93, and an adsorbing layer 91 as described below are not taken into consideration.

In an embodiment that is advantageous from the viewpoint of supporting a sufficient amount of functional material, the thickness of the partition walls 901 is 0.300 mm or less, the cell density is 140 cells/cm² or less, and the cell pitch is 0.85 mm or more. In a preferred embodiment, the thickness of the partition walls 901 is 0.200 mm or less, the cell density is 120 cells/cm² or less, and the cell pitch is 0.91 mm or more. In a more preferred embodiment, the thickness of the partition walls 901 is 0.160 mm or less, the cell density is 110 cells/cm² or less, and the cell pitch is 0.95 mm or more.

In each embodiment as described above, from the viewpoints of ensuring the strength of the honeycomb structure 90 and maintaining lower electrical resistance, the lower limit of the thickness of the partition walls 901 is preferably 0.010 mm or more, more preferably 0.020 mm or more, and even more preferably 0.030 mm or more.

In each embodiment as described above, from the viewpoints of ensuring the strength of the honeycomb structure 90, maintaining lower electrical resistance, and increasing a surface area to facilitate reaction, adsorption, and separation, the lower limit of the cell density is preferably 30 cells/cm² or more, more preferably 35 cells/cm² or more, and even more preferably 40 cells/cm² or more.

In each embodiment as described above, from the viewpoints of ensuring the strength of the honeycomb structure 90, maintaining lower electrical resistance and increasing a surface area to facilitate reaction, adsorption and release, the upper limit of the cell pitch is preferably 2.0 mm or less, more preferably 1.8 mm or less, and even more preferably 1.6 mm or less.

In an embodiment that is advantageous in terms of both reducing pressure loss and maintaining strength, the thickness of the partition walls 901 is 0.08 to 0.36 mm, the cell density is 2.54 to 140 cells/cm², and the opening ratio of the cells 901a is 0.70 or more. In a preferred embodiment, the thickness of the partition walls 901 is 0.09 to 0.35 mm, the cell density is 15 to 100 cells/cm², and the opening ratio of the cells 901a is 0.80 or more. In a more preferred embodiment, the thickness of the partition walls 901 is 0.14 to 0.30 mm, the cell density is 20 to 90 cells/cm², and the opening ratio of the cells 901a is 0.85 or more.

In each embodiment as described above, from the viewpoint of ensuring the strength of the honeycomb structure 90, the upper limit of the opening ratio of the cells 901a is preferably 0.94 or less, more preferably 0.92 or less, and even more preferably 0.90 or less.

Although the thickness of the outer wall 900 is not particularly limited, it is preferably determined based on the following considerations. First, from the viewpoint of reinforcing the honeycomb structure 90, the thickness of the outer wall 900 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 900 is preferably 1.0 mm or less, more preferably 0.5 mm, even more preferably 0.4 mm or less, and still more preferably 0.3 mm or less.

As used herein, the thickness of the outer wall 900 refers to a length, in a normal line direction of a side surface of the honeycomb structure 90, from a boundary between the outer wall 900 and the outermost cell 901a or the partition wall 901 to the side surface of the honeycomb structure 90 in the cross section orthogonal to the flow path direction of the honeycomb structure 90.

The length of the honeycomb structure 90 in the flow path direction and the cross-sectional area of the honeycomb structure 11 orthogonal to the flow path direction may be adjusted according to the required size of the adsorption device 2, and are not particularly limited. For example, when used in a compact adsorption device 2 while ensuring a predetermined function, the honeycomb structure 90 can have a length of 2 to 20 mm in the flow path direction and have a cross-sectional area of 10 cm² or more orthogonal to the flow path direction. Although the upper limit of the cross-sectional area orthogonal to the flow path direction of the honeycomb structure 90 is not particularly limited, it is, for example, 300 cm².

The partition walls 901 forming the honeycomb structure 90 are made of a material that can be heated by electric conduction, specifically made of a material having the PTC property. Further, the outer wall 900 may also be made of a material having a PTC property, as with the partition walls 901, as needed. By such a configuration, the adsorbing layer 91 can be directly heated by heat transfer from the heat-generating partition walls 901 (and optionally the outer wall 900). Further, the material having the PTC property has characteristics such that when the temperature increases to exceed the Curie point, the resistance value is sharply increased, making it difficult for electricity to flow. Therefore, when the temperature of the adsorption device 2 becomes high, the partition walls 901 (and the outer wall 900 if necessary) have limited current flowing through them, thereby suppressing excessive heat generation of the adsorption device 2. Therefore, it is possible to suppress thermal deterioration of the adsorbing layer 91 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 170 Ω·cm or less, and more preferably 160 Ω·cm or less, and even more preferably 150 Ω·cm or less. As used herein, the volume resistivity at 25° C. of the material having the PTC property is measured according to JIS K 6271:2008.

From the viewpoints of creating a device that can be heated by electric conduction and have the PTC property, the outer wall 900 and the partition walls 901 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓ Aₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystal grains is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 900 and the partition walls 901 are substantially free of lead (Pb). Specifically, the outer wall 900 and the partition walls 901 preferably have a Pb content of 0.01% by mass or less, and more preferably 0.001% by mass or less, and still more preferably 0% by mass. The lower Pb content can allow the air 10 heated by contact with the heat-generating partition walls 901 to be safely applied to organisms such as humans, for example. In the outer wall 900 and the partition walls 901, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 900 and the partition walls 901 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 900 and the partition walls 901 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. Regarding First Electrode and Second Electrode)

The first electrode 92 and the second electrode 93 are provided on the first end face 21a, 22a and the second end face 21b, 22b, respectively. Applying a voltage between the first electrode 92 and the second electrode 93 allows the honeycomb structure 90 to generate heat by Joule heat.

The first electrode 92 and the second electrode 93 may employ, for example, a metal or alloy containing at least one selected from Cu, Ag, Al, Ni and Si, although not particularly limited thereto. It is also possible to use an ohmic electrode capable of ohmic contact with the outer wall 900 and/or the partition walls 901 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 92 and the second electrode 93 may have a single-layer structure, or may have a laminated structure of two or more layers. When the first electrode 92 and the second electrode 93 have the laminated structure of two or more layers, the materials of the respective layers may be of the same type or of different types.

The thicknesses of the first electrode 92 and the second electrode 93 may be appropriately set according to the method for forming the first electrode 92 and the second electrode 93. The method for forming the first electrode 92 and the second electrode 93 includes metal deposition methods such as sputtering, vapor deposition, electrolytic deposition, and chemical deposition. Alternatively, the first electrode 92 and the second electrode 93 can be formed by applying an electrode paste and then baking it, or by thermal spraying. Furthermore, the first electrode 92 and the second electrode 93 may be formed by joining metal sheets or alloy sheets.

Each thickness of the first electrode 92 and the second electrode 93 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. Regarding First Metal Terminal and Second Metal Terminal)

The provision of the first metal terminal 94 and the second metal terminal 95 facilitates connection to an external power source. The first metal terminal 94 and the second metal terminal 95 are connected to a conductor connected to the external power source.

The metal that makes up the first metal terminal 94 and the second metal terminal 95 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 94 and the second metal terminal 95 is not particularly limited, but it is, for example, 0.01 to 10 mm, typically 0.05 to 5 mm.

The method of connecting the first metal terminal 94 and the second metal terminal 95 to the first electrode 92 and the second electrode 93, respectively, is not particularly limited as long as they are electrically connected. For example, they can be connected by diffusion bonding, a mechanical pressing mechanism, welding, or the like.

### (2-4. Regarding Intermediate Material)

Intermediate materials may be provided between: the first electrode 92 and the second electrode 93; and the first metal terminal 94 and the second metal terminal 95. The provision of the intermediate materials results in high structural freedom of the connection between the first electrode 92 and the second electrode 93 and the first metal terminal 94 and the second metal terminal 95. The intermediate material may be made of non-limiting materials, and it may be the same as the material of the first metal terminal 94 and the second metal terminal 95 as described above. Moreover, the material of the intermediate material may be different from that of the first metal terminal 94 and the second metal terminal 95 as described above. In this case, the intermediate material can be made of a solder, a brazing material, a conductive adhesive, or the like. The method of connecting the intermediate materials to the first metal terminal 94 and the second metal terminal 95 and the first electrode 92 and the second electrode 93 is not particularly limited as long as they are electrically connected. For example, they can be connected by diffusion bonding, a mechanical pressing mechanism, welding, or the like.

### (2-5. Regarding Adsorbing Layer)

As illustrated in FIG. 10, the adsorption device 2 may be provided with an adsorbing layer 91 on each surface of the partition walls 901. The adsorbing layer 91 can be provided on the surfaces of the partition walls 901 (in the case of the outermost cells 901a, the partition walls 901 that define the outermost cells 901a and the outer wall 900). By thus providing the adsorbing layer 91, the functional material contained in the adsorbing layer 91 can be easily heated, so that the desired function due to the functional material can be exerted.

The adsorbent contained in the adsorbing layer 91 is not particularly limited as long as it can exhibit the desired function. The adsorbent has a function of adsorbing moisture, carbon dioxide and/or volatile components in the air. The adsorbing layer 91 may further contain a catalyst. This can allow the adsorption target substances to be purified. By using the adsorbent in combination with the catalyst, the function of the adsorbent to capture the adsorption target substances can be improved.

The adsorbent preferably has a function that can adsorb the removal target component, for example, moisture, carbon dioxide and volatile components, etc., at −20 to 40° C. and release it at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the adsorption target substances. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 91 may be determined according to the size of the cells 901a, and is not particularly limited. For example, from the viewpoint of ensuring sufficient contact with the air 10, the thickness of the adsorbing layer 91 is preferably 20 μm or more, more preferably 25 μm or more, and even more preferably 30 μm or more. On the other hand, from the viewpoint of suppressing separation of the adsorbing layer 91 from the partition walls 901 and the outer wall 900, the thickness of the adsorbing layer 91 is preferably 400 μm or less, more preferably 380 μm or less, and even more preferably 350 μm or less.

The thickness of the adsorbing layer 91 is measured using the following procedure. Any cross section of the honeycomb structure 90 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 90. The thickness of each adsorbing layer 91 visually recognized from the cross-sectional image is calculated by dividing the cross-sectional area by the length of the cells 901a in the flow path direction. This calculation is performed for all the adsorbing layers 91 visually recognized from the cross-sectional image, and an average value thereof is determined to be the thickness of the adsorbing layer 91.

From the viewpoint that the functional material exerts a desired function in the adsorption device 2, an amount of the adsorbing layer 91 is preferably 50 to 500 g/L, more preferably 100 to 400 g/L, and even more preferably 150 to 350 g/L, based on the volume of the honeycomb structure 90. It should be noted that the volume of the honeycomb structure 90 is a value determined by the external dimensions of the honeycomb structure 90.

### (3. Regarding Method for Producing Adsorption Device)

The method for producing the adsorption device 2 according to an embodiment of the invention is not particularly limited as long as it is a method having the characteristics as described above, and can be carried out in accordance with a known method. Hereinafter, the method for producing the adsorption device 2 according to an embodiment of the invention will be specifically described.

A method for producing the honeycomb structure 90 forming the adsorption device 2 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 90 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 90 can be densified.

Further, the heating rate of 20 to 600° C./hour from the temperature of 1150 to 1250° C. to the maximum temperature of 1360 to 1430° C. can allow 1.0 to 10.0% by mass of Bas Ti₁₇O₄₀ crystal particles to be formed in the honeycomb structure 90.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 90 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 92 and the second electrode 93 are formed on the honeycomb structure 90 thus obtained, whereby the adsorption device 2 can be produced. The first electrode 92 and the second electrode 93 can also be formed by metal deposition methods such as sputtering, vapor deposition, electrolytic deposition, and chemical deposition. Further, the first electrode 92 and the second electrode 93 can also be formed by applying an electrode paste and then baking it. Furthermore, the first electrode 92 and the second electrode 93 can also be formed by thermal spraying. The first electrode 92 and the second electrode 93 may be composed of a single layer, but may also be composed of a plurality of electrode layers having different compositions. A typical method for forming the first electrode 92 and the second electrode 93 will be described below.

First, an electrode slurry containing an electrode material, an organic binder, and a dispersion medium is prepared, and the first end face 21a, 22a or the second end face 21b, 22b of the honeycomb structure 90 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 90 is removed by blowing and wiping. The slurry can be then dried to form the first electrode 92 and the second electrode 93 on the first end face 21a, 22a or the second end face 21b, 22b of the honeycomb structure 90. The drying can be performed while heating the adsorption device 2 to a temperature of about 120 to 600° C., for example. Although a series of steps of coating, slurry removal, and drying may be performed only once, the steps can be repeated multiple times to provide the first electrode 92 and the second electrode 93 having desired thicknesses.

The first metal terminal 94 and the second metal terminal 95 are then placed at predetermined positions of the first electrode 92 and the second electrode 93, respectively, and the first electrode 92 and the second electrode 93 are connected to the first metal terminal 94 and the second metal terminal 95, respectively. As a method of connecting the first electrode 92 and the second electrode 93 to the terminals, the method described above can be used. Further, when the intermediate materials are provided between: the first electrode 92 and the second electrode 93; and the first metal terminal 94 and the second metal terminal 95, the intermediate material can be placed at a predetermined position of the first electrode 92 and the second electrode 93 and connected to each other, and then the first metal terminal 94 and the second metal terminal 95 can be placed at a predetermined position of the intermediate material and connected to each other. As a method for connecting these, the method as described above can be used.

It should be noted that the first metal terminal 94, the second metal terminal 95 and the intermediate material may be provided after the adsorbing layer 91 described below is formed.

The adsorbing layer 91 is then formed on each surface of the partition walls 901 and the like of the adsorption device 2 thus obtained, thereby obtaining an adsorption device with functional material-containing layers.

Although the method for forming the adsorbing layer 91 is not particularly limited, it can be formed, for example, by the following steps. The adsorption device 2 is immersed in a slurry containing a functional material, an organic binder, and a dispersion medium for a predetermined period of time, and an excess slurry on the end faces and the outer periphery of the honeycomb structure 90 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 91 on the surfaces of the partition walls 901. The drying can be performed while heating the adsorption device 2 to a temperature of about 120 to 600° C., for example. Although a series of steps of immersion, slurry removal, and drying may be performed only once, the steps can be repeated multiple times to provide the adsorbing layer 91 having the desired thickness on the surfaces of the partition walls 901 and the like.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### EXAMPLES

The invention will be more specifically described by means of the following Examples. The invention is not limited to these examples.

### (Study for Heat Transfer)

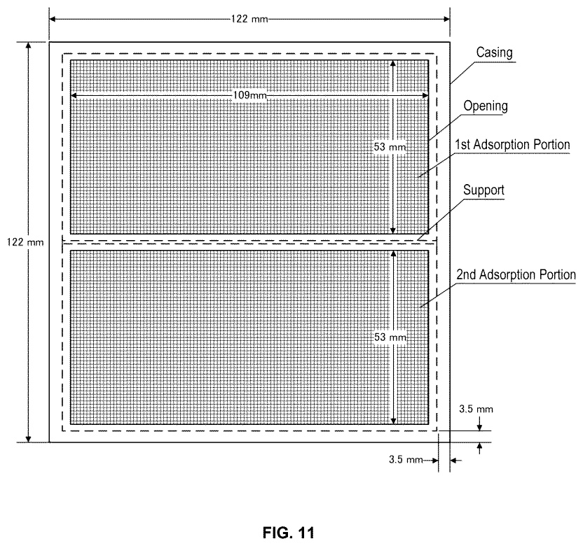

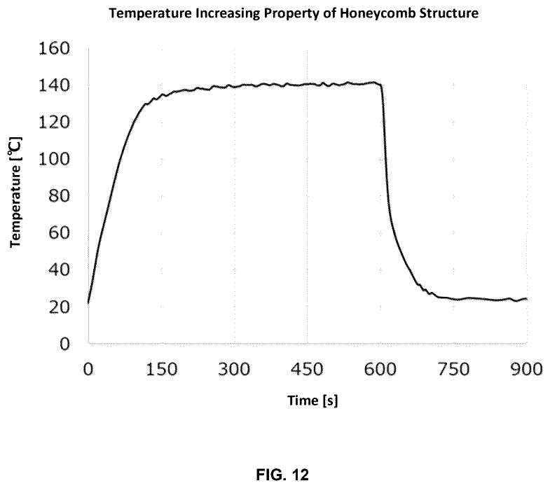

Under the following conditions, a simulation model was prepared in which a first adsorption portion and a second adsorption portion, each consisting of a honeycomb structure, were held in a resin casing, and CAE analysis was used to calculate an amount of heat transfer from one of the first adsorption portion and the second adsorption portion (heating regeneration side) to the other (adsorption side), and the maximum end face temperature of the honeycomb structure on the adsorption side was calculated.
A heat dissipation rate is 5 W/m³/K (minimum heat transfer coefficient of natural convection).
The physical properties used are shown in Table 1 below.
Dimensions of the casing: see FIG. 11.
The casing is made up of a first casing body and a second casing body, and supports are provided at both the first casing body and the second casing body.
Dimensions of the support: changed as shown in Table 2.
Honeycomb structure: the horizontal width is 114 mm, the length is 10 mm, and the vertical width is changed so that the outer surface comes into contact with the inner surface of the casing including the support.
The temperature increasing properties of the honeycomb structure are measured using the values shown in FIG. 12.

TABLE 1

| | | Parts | | | | | |
|---|---|---|---|---|---|---|---|
| | | Honeycomb | | | Electrode | Resin | |
| | | Structure | Adsorbent | Terminal | Layer | Casing | Air |
| Density | 25° C. | 5.7 | 0.82 | 7.7 | 2.7 | 1.67 | 1.18 |
| (g/m³) | 120° C. | | | | | | 0.898 |
| Specific Heat | 25° C. | 470 | 0.665 × 10⁻³ | 460 | 903 | 1100 | 1006 |
| [J/kgK] | 120° C. | | 0.837 × 10⁻³ | | 950 | 1500 | 1013 |
| Thermal | 25° C. | 3.6 | 0.237 | 25.6 | 202 | 0.3 | 0.0260 |
| Conductivity | 120° C. | 3.2 | 0.379 | | 211 | | 0.0326 |
| [W/mK] | | | | | | | |

TABLE 2

| | Width W | Height H | Length L |
|---|---|---|---|
| Level | (mm) | (mm) | (mm) |
| 1 | 0 | 0 | 0 |
| 2 | 1 | 1 | 30 |
| 3 | 1 | 1 | 120 |
| 4 | 1 | 5 | 30 |
| 5 | 3.5 | 5 | 120 |
| 6 | 6 | 1 | 30 |
| 7 | 6 | 1 | 120 |
| 8 | 6 | 5 | 120 |

Using the results of such simulations, a multiple regression analysis was performed under conditions where the response variable was the maximum end face temperature of the honeycomb structure on the adsorption side and the explanatory variables were the width W, height H, and length L of the support. As a result, it was found that the maximum end face temperature of the honeycomb structure on the adsorption side could be expressed by the following equation:

$$80.2 - 8.19 \times W + 2.4 \times H - 0.3358 \times L - 0.0804 \times ( L - 71.3 ) \times ( H / 2 - 2.38 )$$

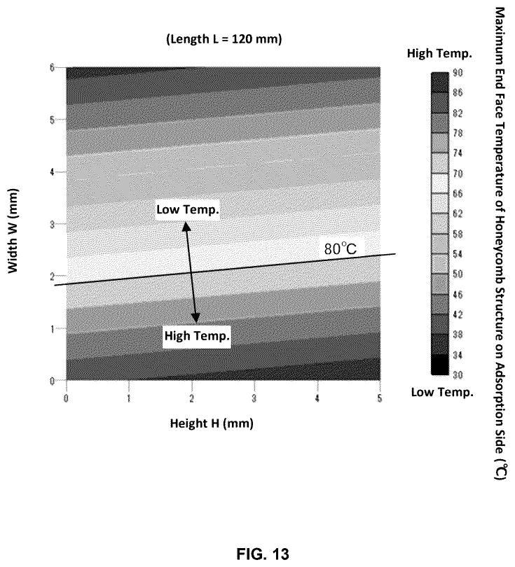

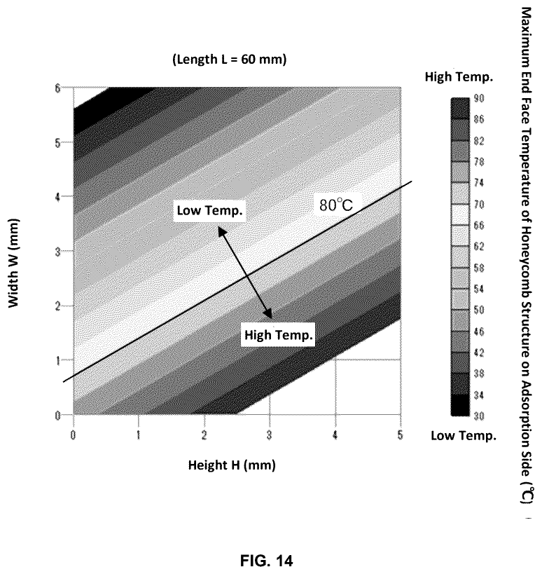

As an example, FIG. 13 illustrates the maximum end surface temperature of the honeycomb structure on the adsorption side when the length L of the support is 120 mm, and FIG. 14 illustrates the maximum end surface temperature of the honeycomb structure on the adsorption side when the length L of the support is 60 mm.

If the maximum end face temperature of the honeycomb structure on the adsorption side is higher than 80° C., it is considered that the adsorption efficiency of the honeycomb structure on the adsorption side will decrease. Therefore, it was found that, by setting the width W, height H and length L of the support so as to satisfy 80.2−8.19×W+2.40×H−0.0358×L−0.0804×(L−71.3)×(H/2−2.38)≤80, a decrease in the adsorption efficiency of the other of the first adsorption portion and the second adsorption portion due to heat from one of the first adsorption portion and the second adsorption portion could be suppressed.

### (Study for Pressure Loss)

Next, the effect of the ratio W/W0 of the width W of the support to the dimension W0 between the outer ends of the casing on the pressure loss was studies as follows.

First, as ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Dimensions of honeycomb structure: horizontal width of 114 mm, vertical width of 57 mm, length of 10 mm;
Shape of cross section of cells orthogonal to flow path direction: quadrangular;
Thickness of partition walls: 0.127 mm;
Thickness of outer peripheral wall: 0.8 mm;
Cell density: 85.3 cells/cm²;
Cell pitch: 1.08 mm;
Opening Ratio of Cells: 0.55 to 0.80;
Cross-sectional area of honeycomb structure orthogonal to extending direction of flow path: 6498 mm²;
Length of honeycomb structure in extending direction of flow path: 10 mm; Volume resistivity of materials making up partition walls (and outer peripheral wall) at 25° C.: 12 Ω·cm; and
Curie point of material making up partition walls (and outer peripheral wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

The honeycomb structure with the first electrode and the second electrode formed was then immersed in a slurry containing zeolite (adsorbent) as a functional material, an organic binder, and water, and the slurry adhering to excess positions (such as the outer periphery) was removed by blowing and wiping, and then dried at about 550° C. to form a functional material-containing layer at the predetermined position.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS430 and having a width of 3.5 mm and a thickness of 0.7 mm. The overall outer shape of the first metal terminal and the second metal terminal was a L-shaped frame shape. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively.

The two honeycomb structures obtained as described above were then used as a first adsorption portion and a second adsorption portion, and were sandwiched between casings (first casing body and second casing body) having the dimensions shown in FIG. 11. Both the first casing body and the second casing body were provided with supports, and the supports were inserted into the gap formed by separating the first adsorption portion and the second adsorption portion in the vertical direction. The length L of each of the supports of the first casing body and the second casing body was 114 mm, which was the same as the width of the honeycomb structure, and the height H was 3.5 mm. The width W of the support was changed, and the ratio W/W0 of the width W of the support to the dimension W0 between the outer ends of the casing was changed.

A sample of the adsorption device obtained as described above was placed in the duct as illustrated in FIG. 15. As shown in FIG. 15, a flow path for the first adsorption portion and a flow path for the second adsorption portion were provided upstream of the sample, and variable dampers were provided to adjust the flow rate of the air flowing through these flow paths. The duct was of split type, and the adsorption device was sandwiched between parts forming the duct from the upstream side and the downstream side. Additionally, pressure sensors were installed upstream of the sample (between the blower and the sample in the adsorption device) and downstream of the sample (at the outlet of the duct). Then, the blower was activated to feed the air at a temperature of 25° C. and at a relative humidity of 40% to the first adsorption portion and the second adsorption portion at a flow velocity of 0.9 m/s, while the pressure at each position was measured using the pressure sensors upstream and downstream of the sample, and the difference between the measured pressures was determined to be the pressure loss.

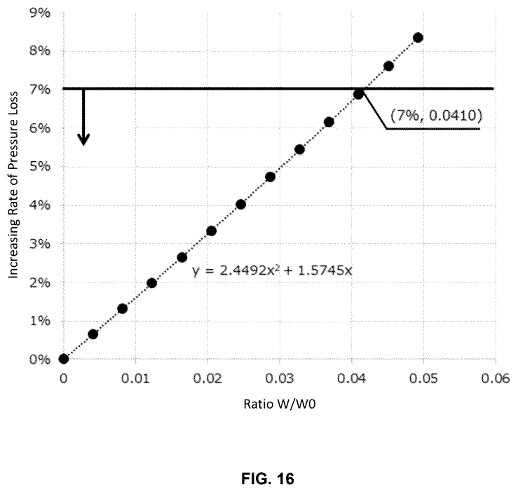

The results of studies for the increasing rate of the pressure loss are shown in FIG. 16. The vertical axis in FIG. 16 represents the increasing rate of the pressure loss relative to the pressure loss when the width W of the support is 0 mm (when there is no support). As shown in FIG. 16, it was found that when the ratio W/W0 was 0.0410 or less, the increasing rate of the pressure loss could be suppressed to 7% or less. From the results, it was found that, from the viewpoint of suppressing an increase in pressure loss, it was preferable to set the ratio W/W0 to 0.0410 or less.

### (Study for Amount of Removal Target Component Adsorbed)

As with the studies for the pressure loss described above, a sample of the adsorption device was placed in the duct as shown in FIG. 15. As shown in FIG. 15, humidity sensors were installed upstream of the sample (between the blower and the sample in the adsorption device) and downstream of the sample (at the outlet of the duct), and the effect of the ratio W/W0 of the width W to the dimension W0 between the outer ends of the casing on the amount of the removal target component (moisture) adsorbed was studied. Specifically, the heating regeneration was executed in the second adsorption portion, and moisture adsorption was executed in the first adsorption portion. The heating regeneration of the second adsorption portion was executed by activating the blower to allow the air at a temperature of 25° C. and at a relative humidity of 40% to flow through the duct at a flow velocity of 0.07 m/s, while applying a voltage of 12 V from a DC power source to the second adsorption portion for 3 minutes. The adsorption of moisture in the first adsorption portion was carried out by allowing the air under the same conditions at a flow velocity of 0.9 m/s to flow through the present duct for 1 minute without applying a voltage to the first adsorption portion. When moisture was adsorbed in the first adsorption portion, the absolute humidity [g/m³] at each position was measured using humidity sensors upstream and downstream of the sample, and the amount of moisture adsorbed [g] was calculated using the following equation:

$$Amount of moisture adsorbed [ g ] = ( absolute humidity [ g / {m}^{3} ] upstream of adsorption device - absolute humidity downstream of adsorption device [ g / {m}^{3} ] ) \times flow rate [ {m}^{3} / min ] \times moisture adsorption time [ min ] .$$

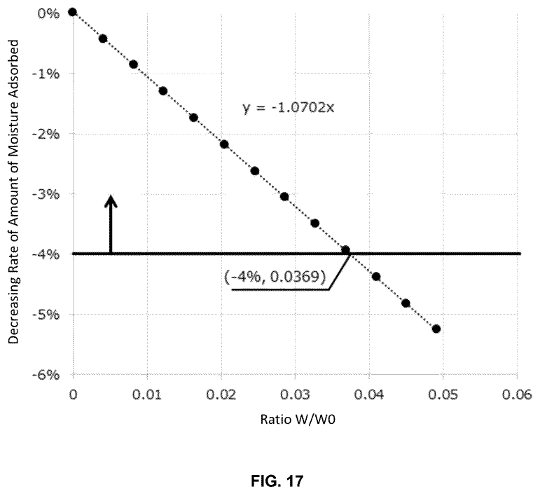

The results of the studies for the decreasing rate of the amount of moisture adsorbed are shown in FIG. 17. The vertical axis in FIG. 17 represents the decreasing rate of the amount of moisture adsorbed relative to the amount of moisture adsorbed when the width W of the support is 0 mm (when there is no support). As shown in FIG. 17, it was found that when the ratio W/W0 was 0.0369 or less, the decreasing rate of the amount of moisture adsorbed could be suppressed to −4% or less. From the results, it was found that, from the viewpoint of suppressing a decrease in the amount of the removal target component adsorbed, it was preferable to set the ratio W/W0 to 0.0369 or less.

### DESCRIPTION OF REFERENCE NUMERALS

1: vehicle air conditioning system
2: adsorption device
10: air
21: first adsorption portion
21a: first end face
21b: second end face
22: second adsorption portion
22a: first end face
22b: second end face
23: heating means
24: casing
240: support
25: gap
90: honeycomb structure
900: outer wall
901: partition wall
901a: cell
91: adsorbing layer
92: electrode
93: electrode

1. A vehicle air conditioning system, comprising an adsorption device comprising:
a first adsorption portion and a second adsorption portion provided in parallel to each other, each of the first adsorption portion and the second adsorption portion comprising an adsorbent configured to adsorb at least one removal target component at a temperature equal to or lower than a predetermined temperature and to desorb the adsorbed removal target component when the temperature exceeds the predetermined temperature;
a heating means configured to heat each of the first adsorption portion and the second adsorption portion; and
at least one casing for holding the first adsorption portion and the second adsorption portion in an integrated manner,
wherein the first adsorption portion and the second adsorption portion are provided to form a gap between them, and
wherein the casing comprises at least one support inserted into the gap between the first adsorption portion and the second adsorption portion.

2. The vehicle air conditioning system of claim 1, wherein, when a direction in which the first adsorption portion and the second adsorption portion are spaced apart from each other is defined as a first direction, a direction which is orthogonal to the first direction and in which first end faces of the first adsorption portion and the second adsorption portion and second end faces of the first adsorption portion and the second adsorption portion are spaced apart from each other is defined as a second direction, and a direction orthogonal to the first direction and the second direction is defined as a third direction, a width W, a height H, and a length L satisfy the following equation:
$$80.2 - 8.19 \times W + 2.4 \times H - 0.3358 \times L - 0.0804 \times ( L - 71.3 ) \times ( H / 2 - 2.38 ) \leq 80$$
in which the width W is a dimension (mm) of the support in the first direction; the height H is a dimension (mm) of the support in the second direction; and the length L is a dimension (mm) of the support in the third direction.

3. The vehicle air conditioning system of claim 2, wherein a ratio W/W0 of the width W to a dimension W0 between outer ends of the casing in the first direction is 0.0410 or less.

4. The vehicle air conditioning system of claim 3, wherein the ratio W/W0 is 0.0369 or less.

5. The vehicle air conditioning system of claim 1, wherein the casing comprises a material having a thermal conductivity of 3.0 W/m/K or less at 25° C. as measured in accordance with JIS R1611: 2010.

6. The vehicle air conditioning system of claim 5, wherein the material of the casing is a resin.

7. The vehicle air conditioning system of claim 1, wherein each of the first adsorption portion and the second adsorption portion comprises: a honeycomb structure having an outer wall and partition walls provided on an inner side of the outer wall, the partition walls defining cells to form flow paths for the air, each of the cells extending from a first end face to a second end face of the honeycomb structure; and an adsorbing layer containing an adsorbent provided on a surface of each of the partition walls, and
wherein the heating means has a pair of electrodes connected to the honeycomb structure, the heating means being configured to heat the honeycomb structure by passing a current through the honeycomb structure via the pair of electrodes,
wherein at least the partition walls of the honeycomb structure comprise a material having a positive temperature coefficient (PTC) property.
